(19) United States
(12) Patent Application Publication
(10) Pub. No.: US 2003/0084109 A1
(43) Pub. Date: May 1, 2003

(54) Efficient message notification system and method for communication devices

(76) Inventor: Daniel A. Balluff, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/016,313

(22) Filed: Oct. 30, 2001

(51) Int. Cl. G06F 15/16

(52) U.S. Cl. 709/206; 709/203

(57) ABSTRACT

A system for facilitating message notification for an electronic communications device. The system includes a first mechanism that organizes, by individual user, individual messages received by the electronic communications device and provides a signal in response thereto. A second mechanism allows the individual users to visually distinguish their received messages based on the signal. In a specific embodiment, the second mechanism includes a display for displaying contents of the individual messages in various visually distinguishable formats corresponding to various individual users. An additional mechanism converts the individual messages into text messages and scrolls the text messages via text that differs by color or font for each of the various individual users. Alternatively, the display shows contents of the individual messages in various message-notification bands that differ based on intended recipients of the individual messages. The bands differ by color or graphic pattern for messages intended for different users.

### BACKGROUND OF THE INVENTION

1. Field of Invention

This invention relates to communication devices. Specifically, the present invention relates to systems and methods for notifying users of convergence devices of pending messages.

2. Description of the Related Art

Convergence devices, such as Internet appliances, often merge fax, telephone, email, and/or voice and text messaging capabilities into one device. Convergence devices are employed in various demanding applications including home automation and corporate communications applications. Such applications demand user-friendly convergence devices that can efficiently organize and display various message types for different users.

Efficient, user-friendly convergence devices are particularly important in applications involving multiple users, such as home automation applications, where all members of a household use the convergence device. Such devices may obviate the need for post-it notes, chalkboard notes, and so on.

Conventionally, convergence devices that consolidate fax, telephone, email, text messaging, and voice messaging applications for multiple users lack efficient mechanisms for notifying individual users of their pending messages. Typically, a user wishing to check the device for messages must navigate through various tedious software menus. Alternatively, a generic beep notifies users of pending messages. The generic beep does not distinguish between messages for various users. Consequently, users must still access the device and navigate through various tedious software menus to determine if they have a message.

Convergence devices often employ conventional message notification technology, such as that used with telephone answering machines. Message notification technologies have not kept pace with the proliferation of convergence devices designed for multiple users and, consequently, often do not distinguish the message notifications between various users. Existing convergence devices inefficiently sort messages and often require that users follow multiple tedious steps to determine if a message is waiting and then to access the message.

Hence, a need exists in the art for an efficient system and method for alerting users of a convergence device that a message exists and for tailoring the notification to the individual user that has a message waiting. There exists a further need for a convergence device that efficiently sorts messages between multiple users and that provides both efficient message notification and efficient user-access to the message.

### SUMMARY OF THE INVENTION

The need in the art is addressed by the system for facilitating message notification for an electronic communications device of the present invention. In the illustrative embodiment, the inventive system is adapted for use a convergence device, such as an Internet appliance. The system includes a first mechanism for organizing individual messages received by the electronic communications device according to individual users of the device and providing a signal in response thereto. A second mechanism automatically enables the individual users to visually distinguish the individual messages based on the signal without additional user input.

In a specific embodiment, the second mechanism includes a display for displaying contents of the individual messages in various visually distinguishable formats corresponding to the various individual users. An additional mechanism converts the individual messages into text messages and scrolls the text messages via text that is visually distinguishable, such as by color or font, for each of the various individual users.

In an alternative embodiment, the display shows contents of the individual messages in various message-notification bands across the display. The bands visually differ based on intended recipients of the individual messages. The bands differ by color or graphic pattern for messages intended for different users.

In the illustrative embodiment, a third mechanism senses when someone enters a room in which the system is installed and provides an enable signal in response thereto to the display. A fifth mechanism automatically activates the display based on the enable signal. The sensor includes a motion sensor and/or a light sensor.

The novel design of the present invention is facilitated by the second mechanism, which enables users of the convergence device to quickly and efficiently determine if a message is waiting for them by viewing the display. The display includes message notifications for different users that are displayed in different colors or patterns, which are pre-assigned to the different users. Users may efficiently access the full message content by selecting the personalized message notification on the display via a keyboard, mouse, touch screen or other input device. Alternatively, users may watch as the message content scrolls across the message notification on the display.

### BRIEF DESCRIPTION OF THE DRAWINGS

FIG. 1 is a block diagram of an efficient communications system employing a convergence device with an efficient message-notification display constructed in accordance with the teachings of the present invention.

FIG. 2 is a flow diagram of a method employed by the convergence device of FIG. 1 for conveniently simultaneously notifying individual users that one or more messages are waiting and displaying content of the pending messages.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

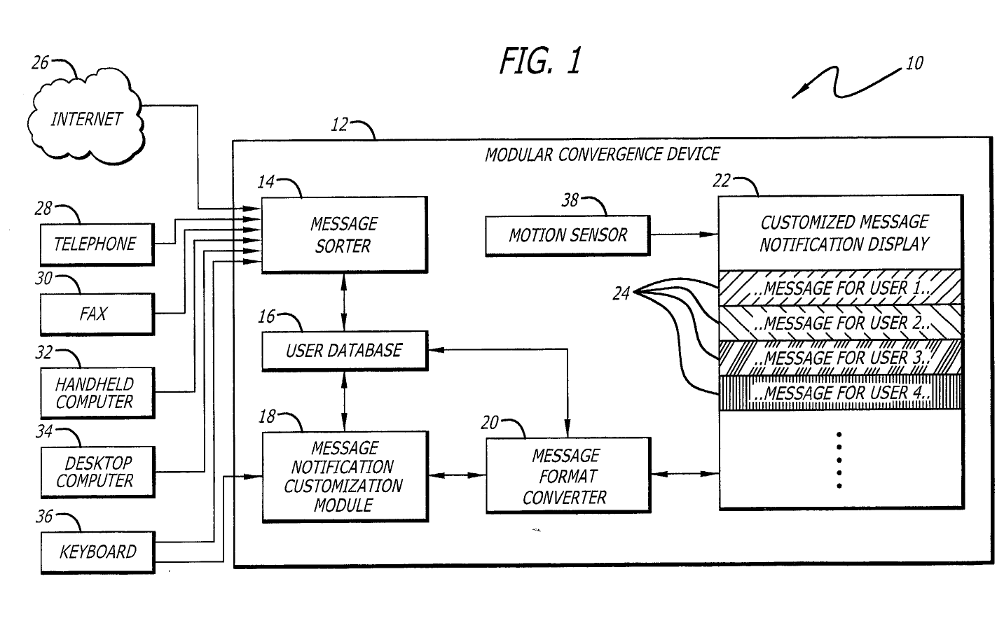

FIG. 1 is a block diagram of an efficient communications system 10 that includes a convergence device 12 with an efficient message-notification display 22 constructed in accordance with the teachings of the present invention. For clarity, various well-known components, such as computer operating systems, hard drives, power supplies, and so on, have been omitted from FIG. 1. However, those skilled in the art with access to the present teachings will know which components to implement and how to implement them to meet the needs of a given application.

The communications system 10 includes the modular convergence device 12, which includes a message sorter 14, a user database 16, a message notification customization module 18, a message format converter 20, and the customized message notification display 22 for displaying various customized message alert bands 24. In the present specific embodiment, the message sorter 14 receives input from the Internet 26, a telephone 28, a fax 30, a handheld computer 32, a desktop computer 34, and a keyboard 36. The message sorter 14 communicates with a user database 16, which communicates with the message notification customization module 18 and the message format converter 20. The message notification customization module 18 receives configuration input from the keyboard 36 and provides output to the message format converter 20, which provides output to the customized message notification display 22.

In the present specific embodiment, the various modules 14-22 are implemented in software running on the modular convergence device 12. Software for implementing the various modules 14-22 of the modular convergence device 12 may be developed by one skilled in the art with access to the present teachings without undue experimentation.

In operation, the message sorter 14 receives various messages including email messages and push content from the Internet 16, voice telephone messages from the telephone 28, fax messages from the fax 30, handwritten messages and typed text messages from the handheld computer 32, word processing documents from the desktop computer 24, and basic text messages from the keyboard 36. The various messages may include different types of messages intended for different users of the modular convergence device 12.

In the preferred embodiment, the modular convergence device 12 is adapted for use with plural users. The various messages received from the communications entities 26-36 may have different intended recipients, since the convergence device 12 may have plural users. Information about each user, such as user name, email address, telephone, fax, mailbox number, and so on, is entered into the user database 16 via the keyboard 36 and the message notification customization module 18. Input devices other than or in addition to the keyboard 36, such as a computer mouse, a microphone, and so on, may be employed to configure the modular convergence device 12 and also to leave messages for different users of the convergence device 12.

The message sorter 14 sorts incoming messages based on the intended recipient(s), which preferably includes one of the users of the modular convergence device 12. The message sorter 14 identifies the address of the incoming message and files the message electronically into the user database 16 under the name(s) of the user(s) associated with the identified message address. The received message may contain an audio file, image file, text file, and so on. For example, telephone messages are stored as digitally encoded audio messages and are sorted into the user database 16 via the message sorter 14 based on an identified user mailbox or telephone number.

Users customize the message notification module 18 by inputting customization information into the message notification customization module 18 via the keyboard 36 or other input device (not shown). The customization information is employed by the message format converter 20 to display received message notifications in a predetermined fashion, such as via pre-selected scrolling color bar, via the customized message notification display 22.

The message notification module 18 includes software for allowing users to assign their own colors or graphics to personalize their message notifications. For example, a first user may decide to be notified of pending messages via a blue color band (see bands 24) with text corresponding to the message displayed therein via the customized message notification display 22. The first user may decide to have the contents of the message scroll in text of a predetermined font and color within the blue color band displayed via the message notification display 22. A second user may decide to have message notifications displayed within a red color band with non-scrolling text. A third user may choose to have message notifications displayed via a band having a predetermined graphic pattern. The message notification customization module 18 maintains notification configuration information specifying how various message notifications for the various users should be displayed. Various additional aspects of the message notifications may be configured by users via the message notification customization module 18. For example, notification width, allowed colors, patterns, fonts, and other display properties, such as text scrolling, of the notification bars 24 are user customizable. Configuration information from the message notification module 18 may be stored in the user database 16 along with various user messages.

The message format converter 20 employs the configuration information from the message notification customization module 18 to selectively convert received messages into the format specified via the configuration information. For example, voice messages received via the telephone 28 and stored under a certain user's name in the user database 16 may be converted to a text message via a speech-to-text module (not shown) in the message format converter 20. The text is then displayed via one of the visually distinguishable message bars 24 according to the predetermined message notification configuration information for that user. The message format converter 20 may include Optical Character Recognition (OCR) software (not shown) to convert faxed and scanned messages into text messages for display via the customized message notification display 22. Alternatively, if the received message is a graphic, the message format converter may display an icon-sized version of the graphic within one of the color bands 24.

Those skilled in the art will appreciate that the contents of received messages may be omitted from the various bands 24 without departing from the scope of the present invention. For example, the content of the message may be replaced with the sender of the message if the sender can be determined by the message sorter 14. In this case, the message format converter 20 may be omitted.

In the preferred embodiment, message notifications for different users are displayed via different color bands or graphics with the contents of the messages shown therein. The message notifications 24 are partially configurable. Different users must choose different visually distinguishable message notification configurations. For example, if a first user selects a solid blue message notification band, other users must employ a band with a different color or pattern so that the message notifications 24 remain visually distinguishable.

A motion sensor 38 senses when a person walks in a room in which the modular convergence device 12 is installed and provides an enable signal in response thereto to the customized message notification display 22. The enable signal from the motion sensor turns on the notification display 22 so that users can view the pending message notifications 24. To save electricity, the message notification display 22 automatically turns off after a predetermined amount of time has elapsed without the convergence device 12 receiving user-input or an enabling signal from the motion sensor 38. The motion sensor 38 may be replaced with another type of sensor, such as a light sensor or acoustic sensor without departing from the scope of the present invention.

Those skilled in the art will appreciate that the intercommunications or interconnections between the various modules of the modular convergence device 12 may be altered or rerouted without departing from the scope of the present invention. For example, the message format converter 20 may be connected directly at the output of the message sorter 14 so that sorted messages output by the sorter 14 are converted to a desired format, such as text, before being stored in the user database 16 under the appropriate user name.

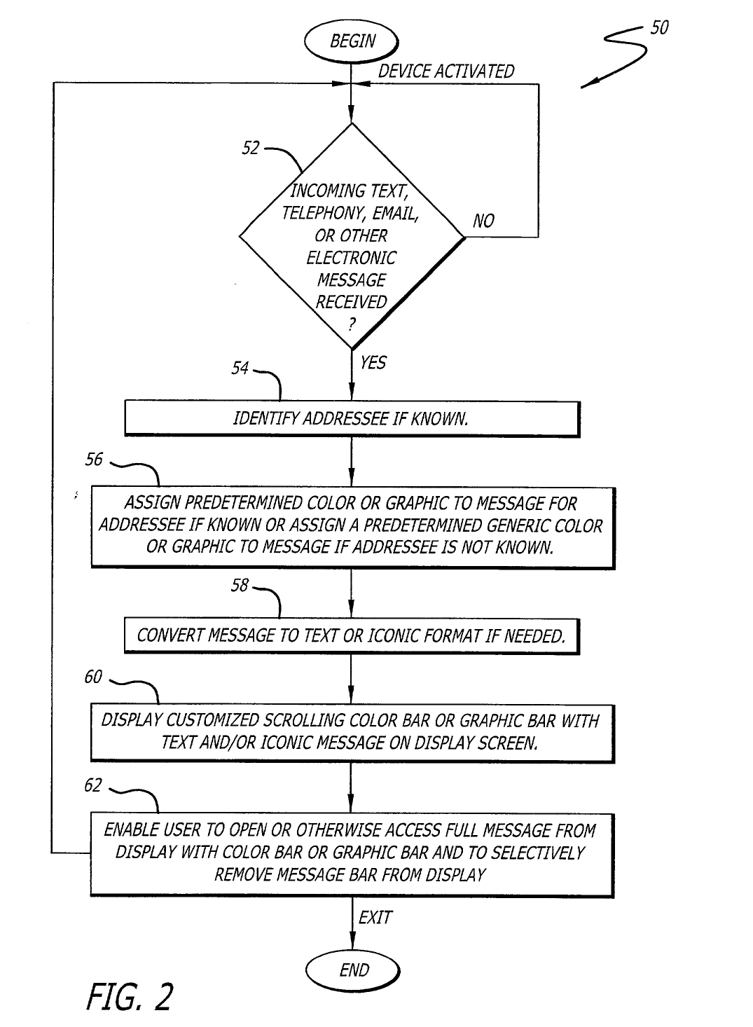

FIG. 2 is a flow diagram of a method 50 employed by the convergence device 12 of FIG. 1 for conveniently simultaneously notifying individual users that one or more messages are waiting and displaying content of the pending messages. With reference to FIGS. 1 and 2, in an initial message-receiving step 52, the message sorter 14 waits for an incoming message, such as a text, telephony, email, digital text, or other electronic message. When a message is received, the message sorter 14 identifies the addressee, which is the intended recipient(s) of the message. Systems and methods for determining addressees of the various types of received messages are known in the art.

In the present specific embodiment, if the message sorter determines a specific addressee(s), then the message notification customization module 18 assigns a predetermined color or graphic to a message notification associated with the received message. Alternatively, if the addressee(s) is not known, then a predetermined generic color or graphic is assigned to the message notification associated with the received message.

Subsequently, in a message-converting step 58, the received message, which has been stored in the user database 16, is converted to text or to an iconic format by the message format converter 20 if the conversion is required. Next, the customized message notification display 22 displays a customized message notification corresponding to the message. The customized message notification is visually distinguishable by intended recipient and, and in the present specific embodiment, is implemented via a scrolling message notification color bar or bar with a predetermined pattern. Scrolling text or an icon that represents the content of the message is displayed within the appropriate customized message notification bar (see 24 of FIG. 1).

Subsequently, in a message-accessing step 62, a user observes the message notification and any corresponding icons or scrolling text within the message notification bar. A user may then employ the keyboard 36, a computer mouse (not shown), or touch-sensitive functionality of the customized message notification display 22 to select the desired message for further review. The message notification bars 24 may be hyperlinks to a wider display of the full message content. For example, if a first user selects a first displayed message notification, such as by clicking on the notification, the customized message notification display 22 may convert to a display dedicated to efficiently displaying the full unconverted original message content. For example, if the received message is push content received from a news website, selecting the message via the message notification bar will temporarily change the display 22 to show the content of the received message rather than the individual message notification bars 24. If the received message is an image, clicking on an icon corresponding to the image within an associated message bar will cause a larger version of the image to be displayed in via the display 22. If the received message is an audio file, clicking on the corresponding message notification bar or audio icon therein will activate a playback of the message as the message is retrieved from the user database 16 via the message format converter 20.

If the modular convergence device 12 is turned off, unplugged, or otherwise deactivated, the method 50 is complete. Otherwise, control is passed from the message-accessing step 62 back to the message-receiving step 52.

Thus, the present invention has been described herein with reference to a particular embodiment for a particular application. Those having ordinary skill in the art and access to the present teachings will recognize additional modifications, applications, and embodiments within the scope thereof.

It is therefore intended by the appended claims to cover any and all such applications, modifications and embodiments within the scope of the present invention.

What is claimed is:

1. A system for facilitating message notification for an electronic communication device comprising:
first means for organizing individual messages received via said electronic communication device according to individual users of said device and providing a signal in response thereto and
second means for automatically enabling said individual users to visually distinguish said individual messages based on said signal.

2. The system of claim 1 wherein said second means includes a display for displaying contents of said individual messages in various visually distinguishable formats corresponding to various individual users.

3. The system of claim 2 wherein said second means includes means for converting said individual messages into text messages and scrolling said text messages via visually distinguishable text, said text differing for each of said various individual users.

4. The system of claim 3 wherein said text differs in color or font based on an intended recipient of said messages or message.

5. The system of claim 2 wherein said visually distinguishable formats include visually distinguishable bands across said display, said bands visually-differing based on intended recipients of said individual messages.

6. The system of claim 5 wherein said visually distinguishable bands differ by color, each band associated with a predetermined color assigned to a specific user.

7. The system of claim 5 wherein said visually distinguishable bands differ by graphical pattern.

8. The system of claim 2 further including third means for sensing when one of said individual users enters a room in which said system is installed and providing an enable signal in response thereto.

9. The system of claim 8 further including fifth means for automatically activating said second means based on said enable signal.

10. The system of claim 9 wherein said sensor includes a motion sensor or a light sensor.

11. A modular convergence device that efficiently notifies multiple users of pending messages comprising:
first means for receiving messages associated with one or more addressees and
second means for displaying message notifications corresponding to said messages, said message notifications visually distinguishable according to addressee.

12. The device of claim 11 further including third means for displaying content of said messages in said message notifications.

13. The device of claim 12 further including fourth means for customizing said message notifications according to color or graphic pattern, personalized for each of said multiple users.

14. A system for facilitating message notification for an electronic communications device comprising:
first means for organizing individual messages received via said electronic communications device according to individual users of said device and providing a signal in response thereto and
second means for automatically enabling said individual users to visually distinguish said individual messages based on said signal via customized message notification bands having different colors or graphics for different individual users.

15. A method for facilitating message notification for an electronic communications device comprising the steps of:
organizing individual messages received via said electronic communications device according to individual users of said device and providing a signal in response thereto and
automatically enabling said individual users to visually distinguish said individual messages based on said signal.
